(19) United States
(12) Patent Application Publication
(10) Pub. No.: US 2005/0023500 A1
(43) Pub. Date: Feb. 3, 2005

(54) Tap for discharging limited gas volumes from a gas cylinder, especially for inflating balloons

(76) Inventor: Loll Kerger, Mondorf-les-Bains (LU)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/897,762

(22) Filed: Jul. 23, 2004

(30) Foreign Application Priority Data
Jul. 29, 2003 (EP) 03077371.7

(51) Int. Cl. F16K 31/00

(52) U.S. Cl. 251/339

(57) ABSTRACT

The invention relates to a tap for use in discharging limited volumes of gas, especially for inflating balloons for children, having a flexible sealing element (38) mounted on a manually actuatable control lever (32) and having two sealing surfaces, each of which cooperates with a tap seat (28,30) formed on the body (12) of the tap (10). One of the seats (28) is adapted to be engaged by an inner sealing surface of the sealing element (38) and the other seat (30) surrounding the first seat (28) cooperating with a second external sealing surface provided on a flexible circumferential lip (38″) of the sealing element (38). The flexible lip (38″) is provided with circumferentially spaced radial slots (39) in the outer edge thereof to limit the gas flow during initial opening movement of the tap (10) in a discharge mode of operation.

### CROSS-REFERENCE TO RELATED APPLICATIONS

This application claims priority to European Application No. 03077371.7 filed Jul. 29, 2003.

### BACKGROUND OF THE INVENTION

The invention concerns a tap adapted to be mounted on a gas cylinder for use in discharging limited or small gas volumes from the cylinder, such as for inflating balloons for children.

In the state of the art a valve assembly for discharging small gas volumes from a gas cylinder for inflating balloons consisted of a tap provided with a pressure reducer and an outlet valve for the bleed gas, as disclosed in the German laid open publication DE 196 03 313 A1. This assembly is very complex and cannot be economically produced.

In the German laid open publication DE 40 08 707 A1 there is disclosed a device for inflating balloons, such as balloons for children, which comprises a pivotal manually actuatable lever mounted in a valve body. There is provided a single seat valve comprising a valve element provided on the lever and cooperating with a sealing element in the valve body. A flow rate limiting means is provided which is effective in all positions of the actuating lever including the gas cylinder filling mode.

### BRIEF SUMMARY OF THE INVENTION

The object of the present invention is to avoid this disadvantage and to provide a tap of the recited type of simple construction and which can be economically produced and limits the flow rate only in the initial tap opening phase in the gas discharge mode.

To solve this object there is provided in accordance with the invention a tap adapted to be mounted on a gas cylinder to permit discharging therefrom of limited gas volumes, i.e. to inflate balloons, comprising a tap body forming a stationary tap member; a control lever adapted to be manually actuated and forming a movable tap member; a first tap seat provided on one of the tap members and cooperating with a first sealing element surface provided on the other of the tap members, said first sealing element surface being in tight engagement with the first seat in a closed position of the tap and being at least partly spaced therefrom in an open position of the tap; a second tap seat being provided on one of said tap members and cooperating with a second sealing element surface provided on the other of the tap members; and at least one bleed passage being formed in one of the second sealing element surface and the second seat, said bleed passage permitting a restricted gas flow between the second seat and the second sealing element surface at least during an initial opening phase of the tap in a discharge mode of operation thereof.

This tap comprises only two main parts, namely the tap body and the control lever. Two tap seats are provided which cooperate with two sealing element surfaces. The first seat and the first sealing element surface serve as a principal opening/closure means of the tap and the second tap seat in cooperation with the second sealing element surface serving as a secondary opening/closure means and as means for restricting the flow rate to prevent gas from discharging suddenly from the gas cylinder in large volumes and at high speed in the initial phase of the discharge mode of operation. Thus, the tap of the invention is a double seat tap. A special pressure reducer is not necessary.

According to an advantageous feature of the double seat tap to the invention the two seats and the two sealing surfaces are disposed and arranged so that, when the tap is closed, the second seat, by engaging the second sealing surface, causes a deflection, in axial direction of the tap of at least a portion of a sealing element provided with the second sealing surface.

The two seats are preferably concentric with one another and formed on the tap body and the two sealing element surfaces are preferably concentric with one another and carried on the control lever.

According to another advantageous feature of the tap according to the invention the second seat is disposed radially outwardly of the first seat and the second seat is off-set from the first seat in an upstream direction with respect to the gas flow direction through the tap in a discharge mode of operation, and the second sealing surface is disposed radially outwardly of the first sealing surface, and the second sealing surface is offset from the first sealing surface in an upstream direction with respect to the gas flow direction through the tap in the discharge mode of operation.

The bleed passage may be formed in the second sealing surface by a slot formed in the outer circumference of the sealing element provided with the second sealing surface. Instead of this slot the bleed passage may also be formed by an orifice.

According to a preferred embodiment of the tap of the invention the first and the second sealing surfaces are formed on the same sealing element. In this case the sealing element is provided with a circumferential flexible lip provided with the second sealing surface and having a smaller thickness than a portion of the sealing element provided with the first sealing surface and located radially interiorly of the circumferential lip. In the closed position of the tap the first seat is in engagement with the thicker portion of the sealing element and the second seat is in engagement with the lip and deflects the same in upstream direction with respect to the gas flow direction through the tap in the bleed mode of operation, and the at least one bleed passage comprises a slot or an orifice formed in the flexible lip. The flexible lip extends generally radially outwardly in a cantilever type fashion from a body portion of the control lever.

### SHORT DESCRIPTION OF THE DRAWINGS

The invention will now be explained in greater detail with respect to the annexed drawings, wherein:

FIG. 1 shows the double seat tap according to the invention, mounted on a gas cylinder.

FIG. 2 shows the tap of the invention in longitudinal section and in the discharge position.

FIG. 3 shows the seal element both in radial section and in plan view.

FIG. 4 is an enlarged detail of FIG. 2 showing the open position of the tap in the discharge mode.

FIG. 5 shows the double seat tap in vertical section in open position to permit filling of the gas cylinder.

FIG. 6 shows a detail of the tap in filling position.

FIG. 7 shows a partial view of the tap in closed position.

### DETAILED DESCRIPTION OF THE INVENTION

Referring to FIG. 1, the double seat tap 10 shown partly in elevation and partly in cross section is fixed to a gas cylinder B.

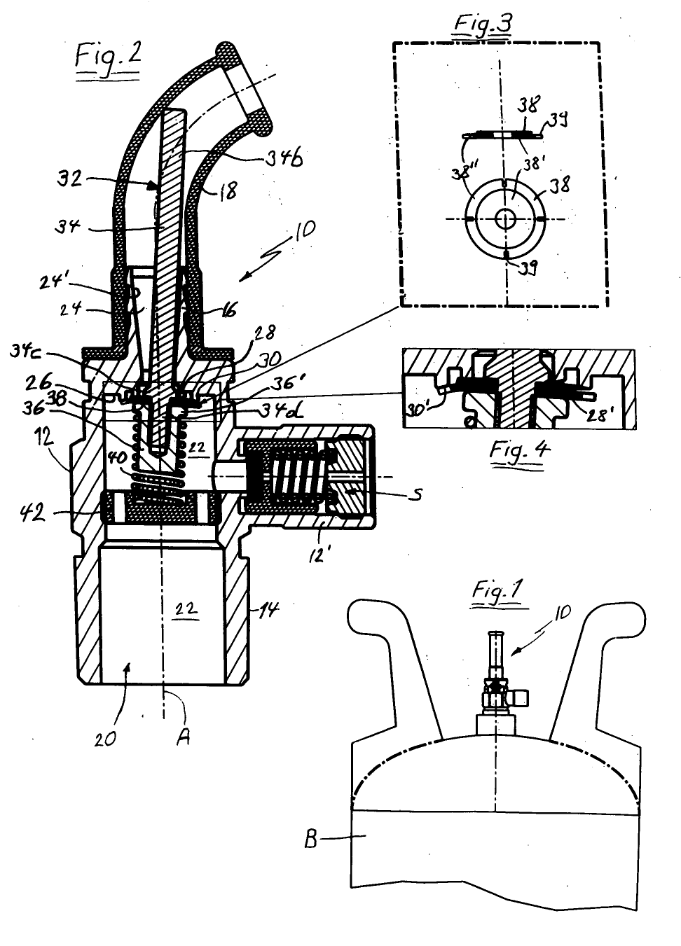

FIG. 2 shows the tap 10 in longitudinal section and in open position for discharging small volumes of gas from the gas cylinder B, i.e. for inflating a balloon. The tap 10 comprises a tap body 12 having an exteriorly threaded end 14 (the thread is not shown) for connecting the tap 10 to a gas cylinder B. At its upper end the tap body 12 comprises an outlet sleeve or connector 16 of reduced diameter on which there is mounted an annular flexible sleeve 18 of rubber or any other appropriate flexible material. The flexible sleeve 18 forms a flexible outlet tube for the gas and elongates the outlet sleeve 16.

The body 12 of the tap 10 is provided with a longitudinal axial passage 20 having different diameters and comprising a lower portion of larger diameter 22 and an upper portion of smaller diameter 24. Between the two portions of larger and smaller diameter 22 and 24 there is provided a radial shoulder 26 having two concentric angular tap seats 28 and 30 spaced from one another in radial direction and terminating at different axial positions along the longitudinal axis A of the tap. The two tap seats 28 and 30 are each provided with an angular conical surface 28′ and 30′ oriented towards the exteriorly threaded end 14 provided for connecting the tap 10 to the gas cylinder B. The conical surface 30′ of the external seat 30 has a cone angle of less than 180° and the cone angle of the conical surface 28′ of the first seat 28 is greater than 180°. In other words the conical surfaces 28′ and 30′ have an opposite angle of taper relative a transverse plane normal to the longitudinal axis A, and the innermost circumferential edge of the inner conical surface 28′ is closer to the exteriorly threaded end 14 than the outermost circumferential edge of the inner conical surface 28′, while the innermost circumferential edge of the outer conical surface 30′ is more remote from the exteriorly threaded end 14 than the outermost circumferential edge of the outer conical surface 30′. Above the radial shoulder 26 the smaller diameter portion 24 has a conical portion 24′ that diverges or tapers outwardly towards the upper end of the connector 16. This conical portion 24′ extends approximately along the entire length of the connector 16.

Between the upper and lower ends of the body 12 of the tap 10 there is provided a body portion 12′ extending radially and containing a safety valve S of any known construction whose construction is not essential for the understanding of the present invention. This safety valve S will therefore not be described in detail herein.

The double seat tap 10 is also provided with a manual control lever 32 comprising an elongated main member 34 extending through the small diameter portion 24 of the passage 20 so that its lower portion 34a is located in the large diameter portion 22 of the passage 20 and its upper control extremity portion 34b extends upwardly out of the connector 16 to the exterior of tap body 12 but terminating within the flexible sleeve 18. The main member 34 has at its lower portion 34a a radial shoulder 34c and below this radial shoulder 34c there is provided a threaded portion 34d. Threaded on this threaded portion 34d is a cap 36 retaining a seal element 38 by clamping this seal element 38 between the cap 36 and the radial should 34c of the lower portion 34a of the control lever 32. The main member 34 and the cap 36 form a control member body portion.

A helical spring 40 that engages at its lower end a support 42 provided in the larger diameter portion 22 of the passage 20 surrounds the cap 36 and engages at its upper end a flanged head portion 36′ provided at the upper end of the cap 36 in order to urge the control lever 32 upwardly into a tap closed position.

The sealing element 38 is shown in FIG. 3 in radial section and in plan view. The sealing element 38 is provided with a radial inner or central portion 38′ and a flexible circumferential lip 38″ extending completely around the inner portion 38′ and having a smaller thickness than the inner portion 38′. At least the entire flexible lip 38″ extends generally radially outwardly in a cantilever type fashion beyond the flanged head portion 36′ of the cap 36 so as to be deflectable downwardly by the seat 30 when the tap moves to its closed position. A plurality of slots 39 spaced circumferentially from one another are formed in the outer circumference of the flexible lip 38″. According to the embodiment shown four slots 39 are provided but there may be provided less or more than four slots 39. One single slot 39 is sufficient. The thick inner portion 38′ is provided in its center with a hole through which the threaded portion 34d of the main portion 34 of the control lever 32 extends.

In the closed position, shown FIG. 7, of the double seat tap, the upper surface of the thick portion 38′ of the sealing element 38 defining a first sealing element surface is in tight engagement with the internal annular seat 28 and the upper surface of the flexible lip 38″ defining a second sealing element surface is in tight engagement of the outer annular seat 30. In this position the flexible lip 38″ is slightly deflected downwardly (namely upstream with respect to the direction of the gas flow through the tap in the bleed mode of operation) by the external annular seat 30 whose conical annular surface 30′ is disposed at a slightly lower elevation than the conical annular surface 28′ of the internal annular seat 28.

To discharge gas from the gas cylinder B the upper end of the flexible sleeve 18 is gripped manually and deformed or deflected laterally towards one side. This deflection causes an inclination of the control lever 32, as shown in FIG. 2, until it engages the conical surface 24′ of the small diameter upper portion 24 of the passage 20. This inclination of the control lever 32 causes disengagement of the central thick portion 38′ of the sealing element 38 from the internal tap seat 28 on at least a portion its circumference and a limited disengagement of the upper surface of the flexible lip 38″ from the external tap seat 30, as shown in FIG. 4, allowing a limited small gas flow between the upper side of the flexible lip 38″ of the external seat 30 and between the upper side of the thick internal portion 38′ of the sealing element 38 and the internal seat 28. Even if during this initial or first movement of inclination of the control lever 32 the flexible lip 38″ remains initially still in contact with the external seat 30 generally throughout its complete circumferential extent, at least one of the slots 39 already permits a very limited gas flow. At the beginning, the operator may turn the deflected flexible sleeve 18 slightly in one or the other direction in order to “find” one of the slots 39 to permit the initial very small gas flow. If the operator desires to augment the gas flow he increases the inclination of the control lever 32 or urges the control lever 32 by means of the flexible sleeve 18 downwardly to disengage the sealing element 38 by a greater extent from the two seats 28 and 30.

It is pointed out that at the beginning of the opening movement of tap 10, the sealing element 38 is disengaged from the interior main seat 28 while the sealing element 38, due to the deflected condition of the resilient lip 38″, still remains in engagement of the second external seat 30 and the gas flow is initially limited by one or the other or a plurality of the slots 39. In other words, the tap 10 is designed so that at the initial opening of the tap 10, the main opening/closure means (first internal seat 28 and central thick portion 38′ of the sealing element 38) opens first whereas the second or secondary opening/closure means (second external seat 30 and flexible external lip 38″) still remains more or less closed, with the exception of at least one of the slots 39 limiting the gas flow.

The second seat 30 is axially offset from the first seat 28 in an upstream direction with respect to the gas flow in the bleed mode of operation (namely towards the end of the tap 10 connectable to the gas cylinder B) and the second sealing surface is similarly offset from the first sealing surface, but the offset of the two seats 28, 30 is preferably larger than the offset of the two sealing surfaces so that on closure of the tap 10 the second seat 30 engages first the lip 38″ and deflects the same downwardly before the first seat 28 engages the central portion 38′ of the sealing element 38. This deflection of the lip 38″ contributes to obtain a very small gas flow at the beginning of the tap opening movement by first disengaging the central portion 38′ of the sealing element 38 from the first inner seat 28 while the lip 38″ remains still in engagement with the second outer seat 30 and the slot or slots 39 limit the gas flow. The gas flow can be increased by progressively moving the control lever in a valve opening direction causing disengagement of the lip 38″ from the outer seat 30 along a portion of or along the entire circumference thereof. Instead of opening the tap 10 by pivoting the control lever 32 laterally it can also be opened by moving the lever 32 slightly downwardly to initiate a gas discharge mode.

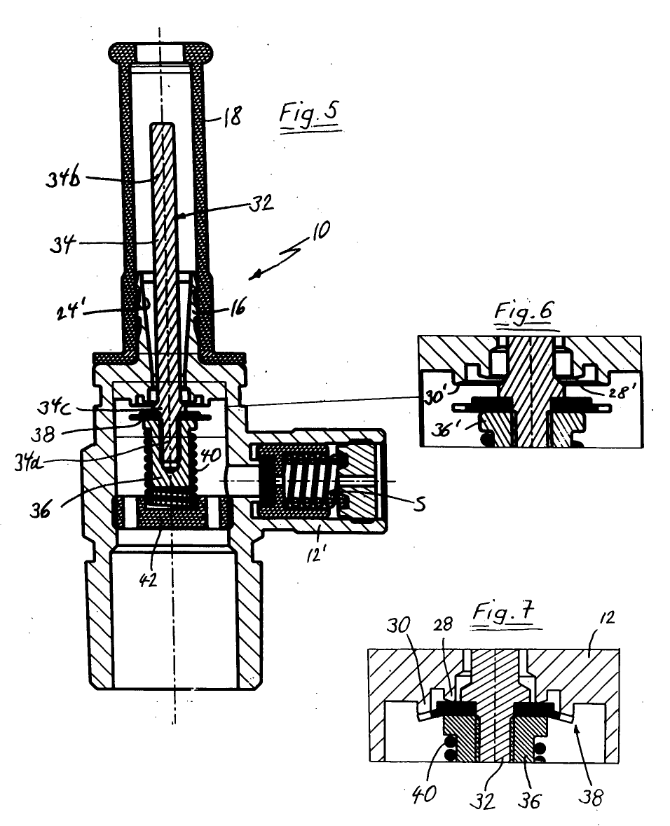

When the flexible sleeve 18 is released it immediately springs back, due to its resilience, towards its initial non deflected position shown in FIG. 5 and the helical spring 40 causes immediately closure of the tap 10, namely the engagement of the sealing element 38 with the two seats 28 and 30.

FIG. 5 shows the position of the tap during filling of the gas cylinder B. In this position the flexible sleeve 18 is not laterally deformed but, by any appropriate means, an axial force is applied to the control lever 32 to move it towards a position of maximum through flow area wherein the sealing element 38 is fully disengaged from both tap seats 28 and 30 to permit high speed filling of the cylinder B.

Instead of the previously described preferred embodiment as shown in the drawings, the sealing element 38 might be provided on the body 12 of the tap 10 and the two seats 28 and 30 might be provided on the control lever 32. In addition, instead of the slots 39 multiple small orifices of circular shape or any other appropriate form could be provided in proximity of the external circumference of the flexible lip 38″.

According to another embodiment, instead of the slots 39 there can be provided a sealing element 38 without the slots and small radial discharge slots (not shown) may be provided in the conical annular surface 30′ of the external seat 30.

Finally, instead of having a single sealing element 38 provided with an inner thick portion 38′ and an external circumferential flexible lip 38″ of smaller thickness, two separate sealing elements of different diameters stacked one on the other or axially spaced from one another, could be provided. According to still another embodiment one of the sealing surfaces may be on a sealing element carried by the control lever and cooperating with a first tap seat on the tap body and the second sealing surface may be on a sealing element provided on the tap body and cooperating with a second tap seat provided on the control lever. Also in such an embodiment the seats and the sealing surfaces may be disposed and arranged to deflect, in the closed position of the tap, at least the portion of the sealing element provided with the second sealing surface.

Other modifications can be made by those skilled in the art to the double seat tap described hereinbefore without departure from the spirit of the invention.

1. A double seat tap adapted to be mounted on a gas cylinder to permit discharging therefrom of limited gas volumes, i.e. to inflate balloons, comprising a tap body forming a stationary tap member; a control lever adapted to be manually actuated and forming a movable tap member; a first tap seat provided on one of said tap members and cooperating with a first sealing element surface provided on the other of said tap members, said first sealing element surface being in tight engagement with said first seat in a closed position with the tap and being at least partly spaced therefrom in open position of the tap; a second tap seat provided on one of said tap members and cooperating with a second sealing element surface provided on the other of said tap members; and at least one bleed passage formed in one of said second sealing element surface and said second seat, said bleed passage permitting a limited gas flow between said second seat and said second seal element surface at least during the initial opening phase of the tap in a discharge mode of operation thereof.

2. The tap according to claim 1, wherein the two seats and the two sealing surfaces are disposed and arranged such that, on closure of the tap, the second seat when engaging the second sealing surface causes a deflection, in axial direction of the tap, of at least a portion of a sealing element provided with said second sealing surface.

3. The tap according to claim 2, wherein the portion of the sealing element provided with the second sealing surface projects generally radially in cantilever type fashion from a control lever body portion.

4. The tap according to claim 1, wherein the two seats are formed on the tap body and the two sealing element surfaces are formed on at least one sealing element provided on the control lever.

5. The tap according to claim 1, wherein the two seats and the two sealing surfaces are concentric with one another.

6. The tap according to claim 1, wherein the second seat is disposed radially outwardly of the first seat and the second seat is axially offset from the first seat in an upstream direction with respect to the gas flow through the tap in the bleeding mode of operation, and the second sealing surface is disposed radially exteriorly of the first sealing surface, and the second sealing surface is axially offset from the first sealing surface in upstream direction with respect to the gas flow through the tap in the discharge mode of operation.

7. The tap of claim 6, wherein the axial offset between the two seats is larger than the axial offset between the two sealing surfaces.

8. The tap according to claim 1, wherein said at least one bleed passage is formed in the second sealing surface by a slot formed in the outer circumference of a sealing element provided with said second sealing surface.

9. The tap according to claim 1, wherein said at least one bleed passage is formed in the second sealing surface by an orifice located in proximity of the external circumference of a sealing element provided with said second sealing surface.

10. The tap according to claim 1, having a single sealing element provided with the first and the second sealing surfaces.

11. The tap according to claim 10, wherein the sealing element is provided with a flexible circumferential lip provided with the second sealing surface and having a smaller thickness than the sealing element portion provided with the first sealing surface and disposed radially interiorly of said lip and wherein in the closed position of the tap the first seat is in engagement with the thicker portion of the sealing element and the second seat is in engagement with the lip and deflects the same in an upstream direction with respect to the gas flow through the tap in the discharge mode of operation.

12. The tap of claim 11 wherein the lip extends generally radially in cantilever type fashion from a control lever body portion.

13. The tap according to claim 11, wherein said at least one bleed passage comprises one of a slot and an orifice formed in the flexible lip.

14. The tap according to claim 1, including a spring means urging the control lever towards the tap closed position.

15. The tap according to claim 1, wherein a tubular sleeve of resilient material forming a gas outlet tube in the discharge mode of operation is fixed to an outlet duct of the tap to elongate said outlet duct, a portion of the control lever extending through said outlet duct to the exterior of the tap body and being received with radial clearance within the interior of the resilient sleeve, said control lever being adapted to be displaced manually by the tubular sleeve with respect to the tap body to open the tap.

16. The tap according to claim 15, wherein the outlet duct has an internal conical passage limiting inclination movement of the control lever when opening the tap in the discharge mode of operation thereof.

17. The tap according to claim 1, wherein the tap body has an end adapted for connection to a gas cylinder, and each of the tap seats has an annular conical surface, one of said annular conical surfaces being a radially inner conical surface and the other annular conical surface being a radially outer conical surface, and wherein a radially innermost circumferential edge of the inner conical surface is closer to said tap end than a radially outermost circumferential edge of the inner conical surface, while a radially innermost circumferential edge of the radially outer conical surface is more remote from said tap end than a radially outermost circumferential edge of the radially outer conical surface.
